(19) United States
(12) Patent Application Publication
(10) Pub. No.: US 2005/0128294 A1
(43) Pub. Date: Jun. 16, 2005

(54) Rear viewing device and method

(75) Inventors: L. Derek Green, Morgan, UT (US); J. Todd Anderson, Morgan, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Trailer Technology.

(21) Appl. No.: 11/009,221

(22) Filed: Dec. 10, 2004

Related U.S. Application Data
(60) Provisional application No. 60/528,295, filed on Dec. 10, 2003.

(51) Int. Cl. H04N 7/18

(52) U.S. Cl. 348/148; 359/844; 340/435

(57) ABSTRACT

A rear viewing device and method is provided for allowing a driver to view behind a vehicle. The device includes a mirror body configured to be attached to a windshield of the vehicle. A mirror can be supported by the mirror body and oriented to enable a user to view out a rear window of the vehicle. In addition, a camera can be included that has a camera body and an angle of view. The angle of view of the camera enables a driver to view areas not viewable through the mirror. A mounting base can attach to a rear area of the vehicle and hold the camera body. The device further includes a video display screen coupled to the mirror body and located above the mirror. The video display screen and mirror enable the driver of the vehicle to see a rear area of a vehicle with substantially reduced blind spots using an image from the camera.

### PRIORITY CLAIM

This application claims the benefit of U.S. Provisional application No. 60/528,295 filed on Dec. 10, 2003.

### FIELD OF THE INVENTION

The present invention relates generally to viewing behind a vehicle.

### BACKGROUND

Backing up a motorized vehicle can be a frustrating and dangerous task. The dangers associated with backing up a motorized vehicle are largely the result of a driver's inability to see objects or children in the area behind the vehicle. This area generally behind the vehicle that the driver cannot see is called a blind spot. The larger the vehicle is, the bigger this blind spot will be. The blind spot behind the vehicle can hide a child, valuable property, another vehicle, or an animal. Even if the driver is skilled and cautious, property damage and even injury or death to others can result from not being able to see what lies behind the vehicle.

The blind spot behind the vehicle also makes it difficult for a driver to judge the distance from the back of the vehicle to another vehicle, a trailer, or an obstacle. The process of coupling a trailer to a bumper, fifth wheel or gooseneck hitch is a tedious process which often entails the assistance of a second party. If a second party is not available, the driver may have to leave the vehicle, view the progress, and re-enter the vehicle in the attempt to couple the trailer and the vehicle at the hitch. This process can be time consuming and frustrating. Parallel parking is also difficult for the same reasons when a driver does not have an accurate view of exactly how close the back of a driver's vehicle is to another vehicle.

Several approaches have been developed to address these problems. Some cars are outfitted with additional mirrors, but on many vehicles it is difficult to attach enough mirrors to allow the driver to see everything behind the vehicle. Using a system with several mirrors can also be problematic because mirrors often provide a skewed image and a distorted perspective.

Other solutions provide a camera that attaches to the back of the vehicle. A camera can be affixed to vehicles over a hitch to help a driver couple the hitch to a trailer. However, in this configuration the image from the camera can be difficult to interpret because the image offers a roughly orthogonal view of an area near the hitch and behind the vehicle.

In another configuration, the camera can be mounted on the back of the vehicle to capture images within the camera's angle of view boundaries. The camera sends video data to a monitor in the cab of the vehicle and allows the driver to see the area behind the vehicle that the camera is monitoring. Camera systems are an improvement over just using mirrors, but a camera alone does not generally capture the entire area of the blind spot behind the vehicle, which leaves regions that the driver still cannot see.

### BRIEF DESCRIPTION OF THE DRAWINGS

FIG. 1 is a front view of a mirror and electronic monitoring device in accordance with an embodiment of the present invention;

FIG. 2a is a top view of a mirror and electronic monitoring device in an embodiment of the invention;

FIG. 2b is a front view of a mirror and electronic monitoring device in accordance with an embodiment of the present invention;

FIG. 2c is a side view of a mirror and electronic monitoring device in an embodiment of the invention;

FIG. 3 is a schematic view of a mirror and electronic monitoring device in an embodiment of the invention;

FIG. 4 is a perspective back view of a mirror and electronic monitoring device in an embodiment of the invention;

FIG. 5a is a back view of a mirror and electronic monitoring device in an embodiment of the invention;

FIG. 5b is a top view of a mirror and electronic monitoring device in accordance with an embodiment of the present invention;

FIG. 5c is a perspective side view of a mirror and electronic monitoring device in an embodiment of the invention; and

FIG. 6 is a flow chart illustrating a method for electronically viewing behind a vehicle in an embodiment of an invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

One embodiment of the present invention is a rear viewing devices that includes a rear view mirror that is combined with an electronic viewing screen (e.g. an LCD or liquid crystal display) and the rear viewing device is connected to a camera in the rear of the vehicle. In the past, an LCD has been located under a rear view mirror in such a way that it removed a portion of the mirror area. Not only is this dangerous because a portion of the field of view is removed but it is disconcerting to the driver of the vehicle because it interferes with the normal rear viewing area.

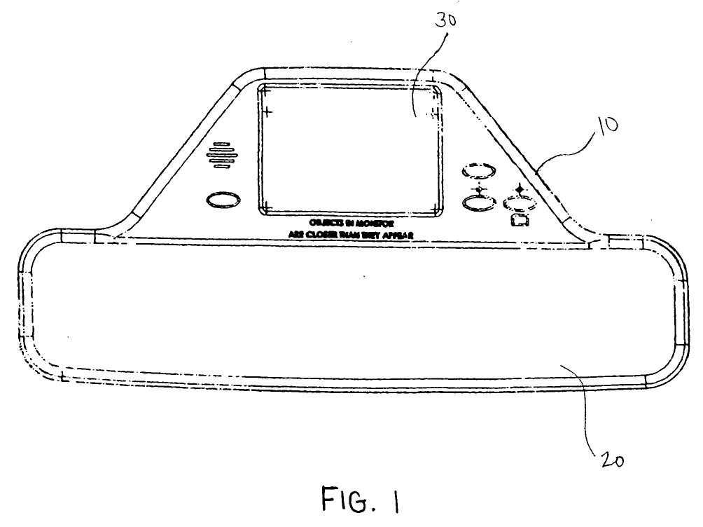

The present invention includes a rear viewing device and method for allowing a driver to view behind a vehicle. FIG. 1 illustrates a rear viewing device that includes a mirror body 10 that is configured to be attached or affixed to a windshield of the vehicle. The mirror body may be made of plastic, metal, composites or other desirable and durable manufacturing materials. A mirror 20 is included and supported by the mirror body. The mirror can be oriented to enable a user to view out a rear window of the vehicle. More specifically, the mirror can be mounted to the windshield or hang from the inside of the vehicle cabin roof. The mirror and mirror body may be mounted inside a windshield of the vehicle in a manner that is known to those skilled in the art.

The device can further include a camera having a camera body and an angle of view for the camera. More specifically, the angle of view of the camera enables a driver to view areas not viewable through the rear view mirror. A mounting base can be included and configured to attach to a rear body panel of the vehicle. The mounting base can then hold the camera body at an appropriate pre-determined angle.

A video display screen 30 is coupled to the mirror body 10 and located above the mirror. The combined video display screen and mirror enable the driver of the vehicle to see a rear area of a vehicle with substantially reduced blind spots. In one embodiment, an LCD screen is combined with a mirror as illustrated in FIG. 1, but other electronic viewing screens may be used such as plasma screens or screens with similar display functions as display technology advances.

The location of the LCD screen is valuable because when the LCD screen is located over the mirror, then the screen does not replace a significant portion of the vehicle driver's viewing area with the LCD screen. When the LCD screen is centered over the mirror, a portion of the driver's viewing area is covered that is not normally significant to driving activities.

Another benefit of the present invention is that the video display screen and the mirror are located in a single viewing area. In other words, a vehicle user can view the video display screen and mirror at the same time without looking to another location within the vehicle to obtain rear view information. In contrast, previous rear view systems have provided a video monitor that is located in an area separate from the rear view mirror such as under the dash board or in the dashboard itself. The problem with locating the video display screen in an area away from rear view mirror is that many users may forget to the use the rear view screen because they have been trained to look at the rear view mirror and this habit has been ingrained ever since they began driving. This single viewing area advantage is provided because the video display screen and the mirror are located in viewing proximity to one another.

Another benefit of providing an LCD screen that is adjacent to the mirror or combined into the same housing is that there are two different independent rear views instead of one. One perspective is provided by the rear view mirror and an additional perspective can be provided by the camera and the LCD video screen. In an ideal embodiment of the invention, the combined video display screen and mirror can eliminate all blind spots in rear viewing.

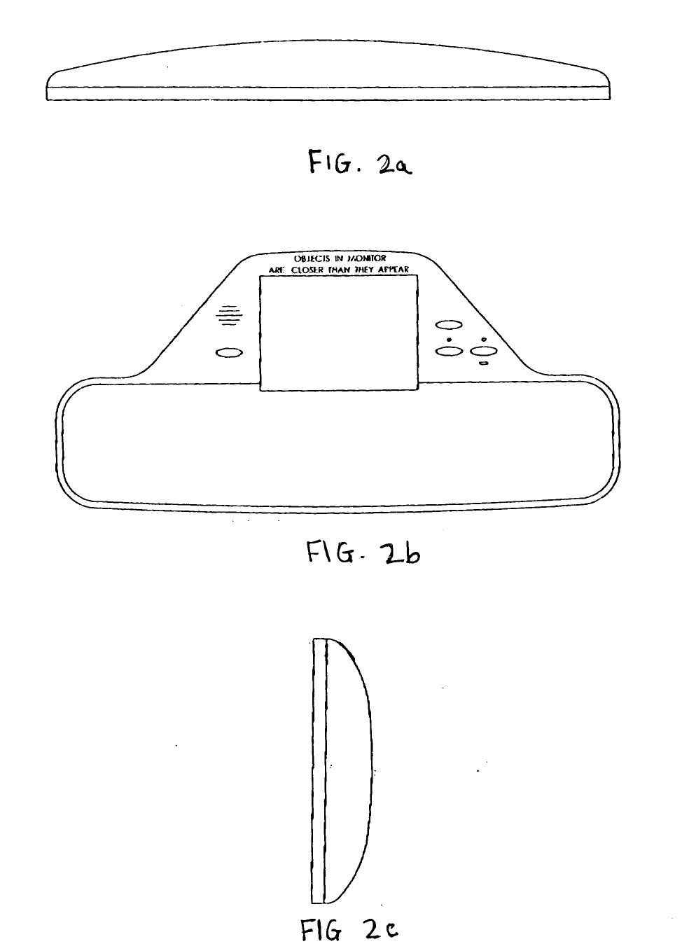

FIG. 2a is a top view of a mirror and electronic monitoring device and FIG. 2b is a front view of a mirror and electronic monitoring device. Any number of accessories can be supported by or embedded in the mirror body. For example, accessories mounted in the mirror body can include a thermometer, navigational screen, clock, or a compass. This mirror and video monitor can integrate electronically dimmed, electronically controlled (EC) and Day-Night mirrors. In addition, the screen can display many other functions such as temperature, compass, navigation, DVD video, On-Star®, clocks, etc. FIG. 2c is a side view of a mirror and electronic monitoring device.

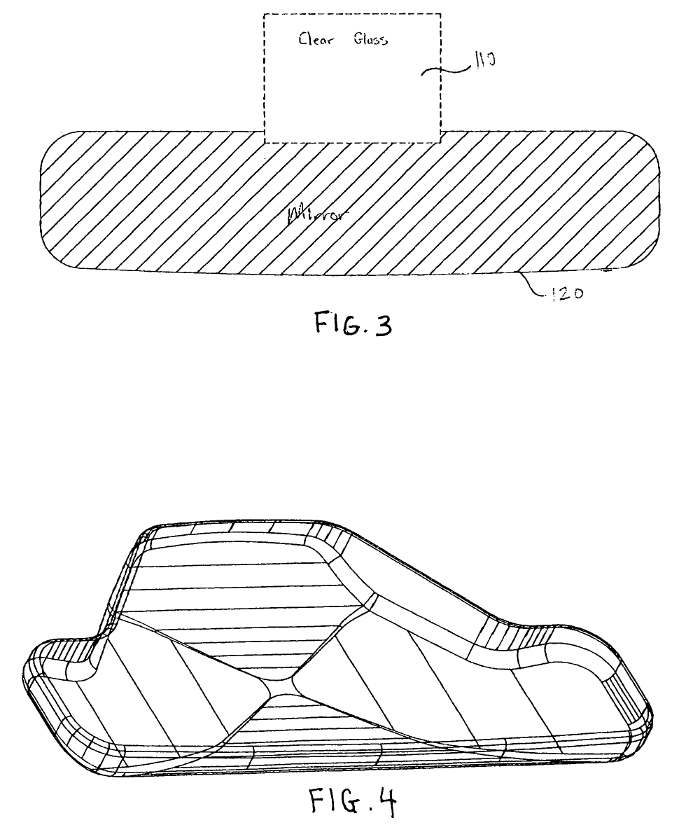

FIG. 3 is a schematic view of a mirror and electronic monitoring device in an embodiment of the invention. A clear glass plate 110 may be provided beneath the surface of which the LCD or video screen can be mounted. Below the glass plate and LCD is a mirror 120 that can be used for rear viewing. The video display screen can be sized to occupy an entire height between the mirror and a ceiling of a vehicle interior. This allows a comparatively large video display to be provided without impeding the driver's field of vision.

In the exemplary figures for the invention, the video display screen is centered above the mirror. This configuration minimizes the amount of the driver's field of vision that is covered. In addition, centering the video display above the mirror avoids obstructing part of the mirror as happens when the video monitor is located below a partially transparent section of a mirror. The video monitor may also be brighter than when the monitor is located below a mirror because there is no additional semi-reflective layer through which the monitor or LCD needs to shine.

Alternative embodiments of the invention can locate the video display or LCD above the mirror but off-center as compared to the mirror or mirror mounting bracket. The video display may be located to the left or right of the center of the mirror. Locating the video display to the right of center of the display is likely to minimize the amount of the driver's field of vision that is not obstructed (for U.S. driving). In contrast, locating the video display to the left of the center of the mirror is a workable configuration but this location may obscure slightly more of the driver's field of view or at a minimum may irritate the driver because of the location.

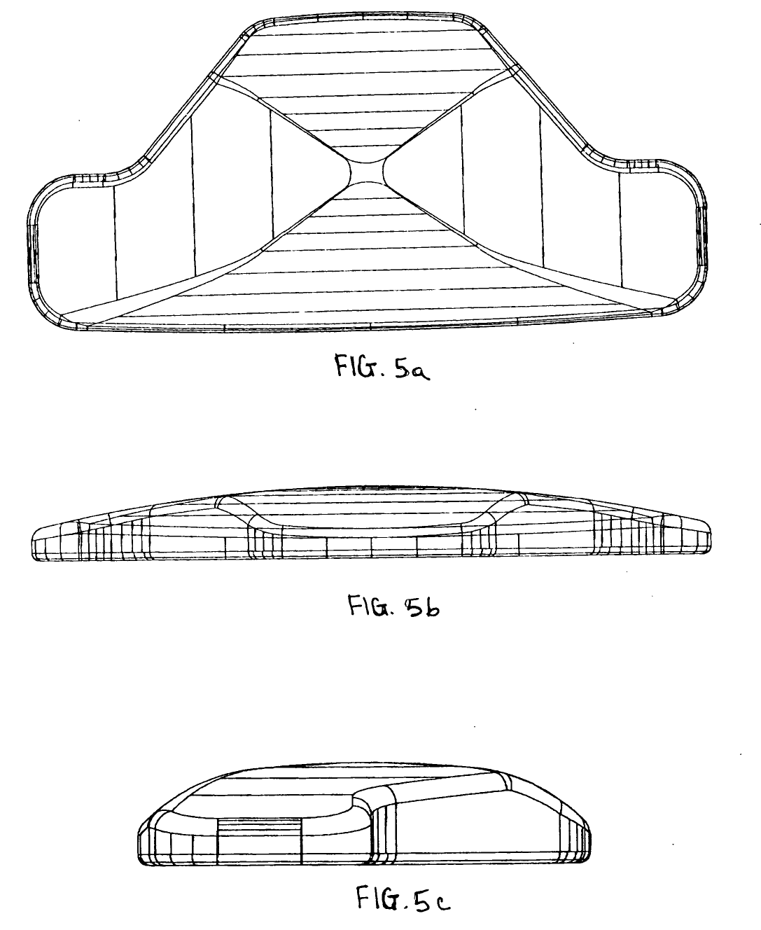

FIG. 4 is a perspective back view of a mirror and electronic monitoring device. FIG. 5a is a back orthogonal view of a mirror and electronic monitoring device. FIG. 5b is a top view and FIG. 5c is perspective side view of a mirror and electronic monitoring device in accordance with an embodiment of the present invention. The connection between the camera and the video display screen can use a wireless connection or a hardwired connection.

In order to enhance communications with the rear of the vehicle, a speaker can be included near the video display screen and a microphone may be located on the rear panel of the vehicle to assist the driver in hearing sounds behind the vehicle. For example, if a child is walking or playing behind the vehicle, then the driver is more likely to hear those sounds using the microphone which helps avoid accidents. In a similar manner, a microphone can be associated with the video display screen. Then a speaker can be located on the rear panel of the vehicle or outside the vehicle to enable the driver to speak to individuals located behind the vehicle. This configuration may allow a driver to warn someone who is located behind the vehicle that the driver intends to backup the vehicle. If desired, these speakers and microphones may be activated only when backing up takes place.

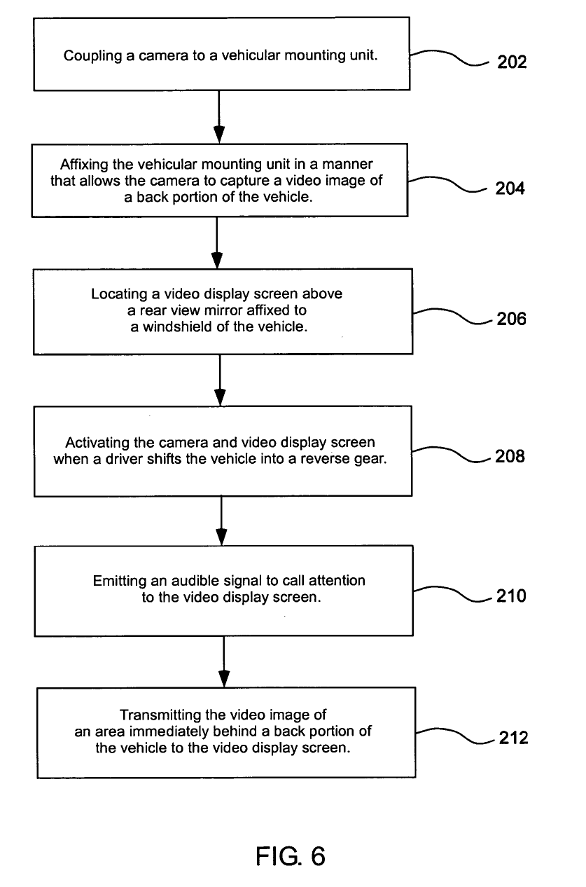

An additional embodiment of the invention includes a method for electronically viewing behind a vehicle as illustrated in FIG. 6. The method includes the operation of coupling a camera to a vehicular mounting unit as in block 202. Then the vehicular mounting unit can be affixed to a rear panel of a vehicle in a manner that allows the camera to capture a video image of an area that substantially spans an area immediately behind a back portion of the vehicle as in block 204. In this description, immediately behind a back portion of the vehicle is generally defined as being a view that includes a portion of the rear of the vehicle and than a portion of the area behind the vehicle. The area captured by the camera may include all or just a portion of the area behind the vehicle depending on the type of camera that is used and the camera angle. For example, a camera with a wide angle lens can be attached to a vehicular mounting unit.

A video display screen can be located above a rear view mirror that is affixed to a windshield of the vehicle as in block 206. The camera and video display screen can be activated when a driver shifts the vehicle into a reverse gear as in block 208. The activation turns on the camera and video system and begins display of the image representing what is located behind the vehicle. Then an audible signal can be emitted to call attention to the video display screen as in block 210. The audible signal can be a chirping sound, a chime, a musical tone, or a melody. Other custom audible signals can be loaded by the end user or vocal instructions may be recorded and played back, such as “Check the rear camera.”

Finally, the video image of an area immediately behind a back portion of the vehicle can be transmitted to the video display screen that is viewable by the driver of the vehicle as in block 212. The camera and video display screen may be deactivated when the driver shifts the vehicle into a forward gear or the screen may be switched to a different mode such as navigation.

The LCD associated with the mirror can turn on automatically when the vehicle is shifted into reverse or override at anytime. This automatic activation provides a constant view while driving in reverse and then removes any distraction to the driver when moving forward because the electronic rear view is turned off. Another benefit activating an electronic viewer or LCD provides is that it offers a hands free activation mechanism which allows a driver to drive the vehicle, without worrying about additional rear view devices that need to be turned on, opened or closed, or other buttons that need to be pushed. In other words, the reverse viewing display may turn on when the car is set to travel in a reverse direction and turn off when shifted into any other position such as park, drive, or in-gear.

The LCD or electronic viewer can include multiple input channels, speakers, microphones or back-up sensors, if desired. A microphone can allow for a voice activated On-Star application or similar system.

A further advantage of the present invention is that it avoids interfering with the driving habits that individuals have built up over many years of driving. For example, when people learn to drive a vehicle they develop the habit of looking at the rear view mirror automatically when a car goes into reverse. This habit is ingrained in vehicle drivers throughout their lives. So a rear view system that makes you look in any place other than the rear view mirror area uses more effort, time, and is less efficient.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A rear viewing device for allowing a driver to view behind a vehicle, comprising:
a mirror body configured to be attached to a windshield of the vehicle;
a mirror supported by the mirror body and oriented to enable a user to view out a rear window of the vehicle;
a camera having a camera body and an angle of view, wherein the angle of view of the camera enables a driver to view areas not viewable through the mirror;
a mounting base configured to attach to a rear area of the vehicle and to hold the camera body; and
a video display screen coupled to the mirror body and located above the mirror, wherein the video display screen and mirror enable the driver of the vehicle to see a rear area of a vehicle with substantially reduced blind spots using an image from the camera.

2. A rear viewing device as in claim 1, wherein the video display screen and the mirror are located in a single viewing area.

3. A rear viewing device as in claim 1, wherein the video display screen is sized to occupy an entire height between the mirror and a ceiling of the vehicle.

4. A rear viewing device as in claim 1, wherein the video display screen is centered above the mirror.

5. A rear viewing device as in claim 1, wherein the video display screen and the mirror are located in proximity to one another.

6. A rear view device as in claim 1, wherein the combined video display screen and mirror eliminate all blind spots in rear viewing.

7. A rear viewing device as in claim 1, further comprising a connection between the camera and the video display screen that is selected from the group consisting of a wireless connection and a hardwired connection.

8. A rear viewing device as in claim 1, further comprising a speaker associated with the video display screen and a microphone located on the rear of the vehicle to assist the driver in hearing sounds behind the vehicle.

9. A rear viewing device as in claim 1, further comprising a microphone associated with the video display screen and a speaker located on the rear of the vehicle to enable the driver to speak to individuals located behind the vehicle.

10. A rear viewing device as in claim 1, further comprising a microphone associated with the video display screen and a speaker located on the rear panel of the vehicle to enable the driver to speak to individuals located behind the vehicle.

11. A rear viewing device as in claim 1, further comprising an accessory supported by the mirror body selected from the group consisting of a thermometer, navigational screen, clock, and a compass.

12. A method for electronically viewing behind a vehicle, comprising the steps of:
coupling a camera to a vehicular mounting unit; and
affixing the vehicular mounting unit to a rear of a vehicle in a manner that allows the camera to capture a video image of at least an area immediately behind a vehicle; and
locating a video display screen above a rear view mirror affixed to a windshield of the vehicle;
employing the camera and video display screen when a driver shifts the vehicle into a reverse gear;
emitting an audible signal to call attention to the video display screen; and
transmitting a video image of a back portion of the vehicle to the video display screen that is viewable by the driver of the vehicle.

13. A method as in claim 12, further comprising the step of deactivating the camera and video display screen when the driver shifts the vehicle into a forward gear.

14. A method as in claim 12, further comprising the step of sending navigation information to the video display screen when the video display screen is not being used for rear viewing.

15. The method as in claim 12, wherein the step of coupling a camera to a vehicular mounting unit further comprises the step of coupling a camera with a wide angle lens to a vehicular mounting unit.

16. The method as in claim 12, wherein the step of emitting an audible signal further comprises the step of emitting an audible signal that is selected from the group consisting of a chirping sound, a chime, a musical tone, and a melody.

17. The method as in claim 12, wherein the step of emitting an audible signal further comprises the step of emitting an audible signal selected by a user.

18. A method for electronically viewing behind a vehicle with a rear view mirror, comprising the steps of:
coupling a camera to a vehicular mounting unit; and
affixing the vehicular mounting unit to a vehicle in a manner that allows the camera to capture a video image of an area that substantially spans a portion of an area behind the vehicle; and
locating a video display screen above and in proximity to the rear view mirror;
activating the camera and video display screen when a driver shifts the vehicle into a reverse gear;
transmitting the video image of area behind a back portion of the vehicle to a video display that is viewable by the driver of the vehicle with the rear view mirror; and
deactivating the camera and video display screen when the driver shifts the vehicle into a forward gear.

19. The method as in claim 18, wherein the step of transmitting video data further comprises the step of transmitting video data using a wireless connection or a hardwired connection.

20. The method as in claim 18, wherein the step of attaching a video display to the vehicle further comprises the step of attaching an LCD screen above the rear view mirror.

21. A rear viewing device for allowing a driver to view behind a vehicle, comprising:
a mirror body configured to be attached to a windshield of the vehicle;
a mirror supported by the mirror body and configured to enable a user to view out a rear window of the vehicle;
a camera having a camera body attached to a rear body panel of the vehicle, wherein camera has an angle of view of the camera that enables a driver to view areas behind the vehicle that are not viewable through the mirror; and
a video display screen located directly above the mirror in a location that allows the vehicle driver to view the video display screen with images from the camera and mirror at the same time, wherein the video display screen and mirror are located in proximity to one another to enable the driver of the vehicle to see a rear area of a vehicle without any blind spots.

22. A rear viewing device as in claim 21, wherein the video display screen centered above the mirror.

23. A rear viewing device as in claim 21, wherein the video display screen is located to the right or the left of the mirror.
